(19) United States
(12) Patent Application Publication
(10) Pub. No.: US 2026/0290926 A1
(43) Pub. Date: Sep. 24, 2026

(54) METHOD FOR OBTAINING CATHODE ACTIVE MATERIALS FROM BLACK MASS OF BATTERIES AND APPARATUS FOR OBTAINING CATHODE ACTIVE MATERIALS TO BE USED IN SUCH METHOD

(71) Applicant: Circular Materials S.R.L., Cambiago (IT)

(72) Inventor: Marco BERSANI, Padova (IT)

(21) Appl. No.: 19/476,035

(22) PCT Filed: Apr. 18, 2024
(86) PCT No.: PCT/EP2024/060625

§ 371 Date: Oct. 16, 2025

(30) Foreign Application Priority Data
Apr. 21, 2023 (IT) 102023000007830

(51) Int. Cl. H01M 10/54; C22B 7/00

(52) U.S. Cl. CPC H01M 10/54; C22B 7/007

(57) ABSTRACT

A method for obtaining cathode active materials from black mass, which consists in:
subjecting the black mass to a leaching operation, by using a leaching agent, thus obtaining a leaching liquor,
subjecting the leaching liquor to a step of mixing with supercritical water, generating nanoparticle precipitation, thus obtaining a nanoparticle solution of metal oxides,
subjecting the nanoparticle solution to a step of mixing with a stream of additives and/or cold water to obtain a stoichiometrically correct and/or chemically stable nanoparticle solution,
cooling the stoichiometrically correct and/or chemically stable nanoparticle solution, thus obtaining cathode active materials and/or precursors of cathode active materials.

The present application is a U.S. national stage entry under 35 U.S.C. § 371 of PCT International Patent Application No. PCT/EP2024/060625, filed Apr. 18, 2024, which in turn claims priority to Italian Patent Application No. 102023000007830, filed Apr. 21, 2023, the entirety of each of which are incorporated herein by reference.

The present invention relates to a method for obtaining cathode active materials from black mass of exhausted batteries.

The invention also relates to an apparatus for obtaining cathode active materials, which can be used in such a method.

The term “black mass” refers, in industry, to a type of electronic refuse deriving from exhausted battery cells that have been crushed, shredded, and subjected to the removal of plastic components, metallic electrodes, and electrolyte. Black mass is constituted by an anode and cathode active mixture.

Black mass contains mixtures of valuable metals including lithium (Li), manganese (Mn), cobalt (Co) and nickel (Ni).

In particular, black mass takes the form of a fine black powder, and is composed in highly variable proportions by a carbon-containing fraction (lampblack, graphite), Li, cathode active material (usually based on Ni and/or Mn and/or Co and/or aluminum (Al) and/or vanadium (V) and/or iron (Fe) and/or copper (Cu) and/or titanium (T) and/or zinc (Zn) and/or zirconium (Zr) and/or phosphate (PO₄) and/or the like), organic bonds, solvent.

The organic fraction strongly depends on the mechanical separation process used: in the state of the art it is possible to reduce the organic content to the minimum for approximately 85% of recovered black mass.

The expression “cathode active material” means a chemical compound that is electrochemically active in terms of the capacity to intercalate and de-intercalate lithium through spontaneous or induced oxidation reactions.

Nowadays, the demand for precious metals or metals of high economic value (in particular Li) is increasing owing to the considerable use that is made of these materials in industry, in particular in the electronics and automotive industries.

However, reserves of such metals are nearing exhaustion and/or their extraction is complex, expensive and inconvenient.

In recent years therefore, the recovery of precious metals from black mass is gaining ground, in order to obtain cathode active materials.

For industry and legislators, the strategic necessity to recover lithium and to conduct the recovery process in accordance with stringent environmental sustainability parameters has brought about a transition from thermal recovery processes, of pyrometallurgical type, to wet recovery processes, of hydrometallurgical type.

In hydrometallurgical recovery processes, metals contained in black mass are extracted with a leaching process which begins with a chemical attack, usually acid, aimed at the solubilization of the metals and their separation from the carbon-containing fraction.

Nowadays the leaching process used is based on the use of sulfuric acid which is effective in bringing all cathodic metals, lithium and impurities into a solution.

Subsequently purification processes are carried out, such as for example chemical precipitation, electrowinning or solvent extraction, in order to separate the impurities and obtain pure fractions of the metals of interest (usually Co, Ni, Li), typically in the form of sulfate salts of the heavy metals.

This purified compound is then subjected to successive extractions in the solvent phase in order to obtain sulfate salts of the heavy metals (such as Ni, Mn, Co), and the precipitation of lithium carbonate Li₂CO₃.

Lithium carbonate is the precursor used for the synthesis of cathode active materials and for the lithium salts used in the electrolytes of lithium ion batteries, commonly used to power cellular phones and laptop computers.

Lithium carbonate and the sulfates of heavy metals are subsequently used in a subsequent, external method, in order to obtain cathode active materials.

Such prior art has a number of drawbacks.

First of all, in order to be capable of executing such a method for obtaining cathode active materials starting from black mass, it is necessary to have a plant that is markedly complex from the technical/constructive point of view, and considerably expensive in terms of the initial investment to build it, and in terms of the operation and maintenance costs.

Furthermore, such a method produces an enormous quantity of waste to be disposed of, which is comparable to the quantity of cathode active materials obtained, with consequent non-negligible environmental impact and considerable pollution.

The aim of the present invention is to provide a method for obtaining cathode active materials from black mass of exhausted batteries and an apparatus for obtaining cathode active materials, which can be used in such a method, which are capable of avoiding the drawbacks of the prior art in one or more of the above-mentioned aspects.

Within this aim, an object of the invention is to provide a method for obtaining cathode active materials from black mass and an apparatus for obtaining cathode active materials, which can be used in such a method, which are simpler and more economic than similar, conventional methods and apparatuses.

Another object of the invention is to provide a method for obtaining cathode active materials from black mass and an apparatus for obtaining cathode active materials, which can be used in such a method, which enable a reduced and/or absent production of waste to be disposed of, so resulting in a reduced environmental impact with respect to similar, conventional methods and apparatuses.

A further object of the present invention is to overcome the drawbacks of the prior art in an alternative manner to any existing solutions.

Another object of the invention is to provide a method for obtaining cathode active materials from black mass of exhausted batteries and an apparatus for obtaining cathode active materials, which can be used in such a method, that are highly reliable, easy to implement, and at low cost.

This aim and these and other objects which will become more apparent hereinafter are achieved by a method for obtaining cathode active materials from black mass, which consists in:
subjecting said black mass to a leaching operation, by using a leaching agent, thus obtaining a leaching liquor,
subjecting said stoichiometrically correct leaching liquor to a step of mixing with supercritical water, generating nanoparticle precipitation, thus obtaining a nanoparticle solution of metal oxides,
subjecting said nanoparticle solution to a step of mixing with a stream of additives and/or cold water to obtain a stoichiometrically correct and/or chemically stable nanoparticle solution,
cooling said stoichiometrically balanced and/or chemically stable nanoparticle solution, thus obtaining said cathode active materials and/or precursors of cathode active materials.

This aim and these and other objects which will become more apparent hereinafter are achieved by an apparatus for obtaining cathode active materials, characterized in that it comprises:
first pumping means,
heating means downstream of said first pumping means,
second pumping means,
third pumping means,
fourth pumping means,
a mixer,
cooling means,
a back pressure regulator.

Further characteristics and advantages of the invention will become better apparent from the detailed description that follows of a preferred, but not exclusive, embodiment of the method for obtaining cathode active materials from black mass and of the apparatus for obtaining cathode active materials according to the invention, which are illustrated by way of non-limiting example in the accompanying drawings wherein:

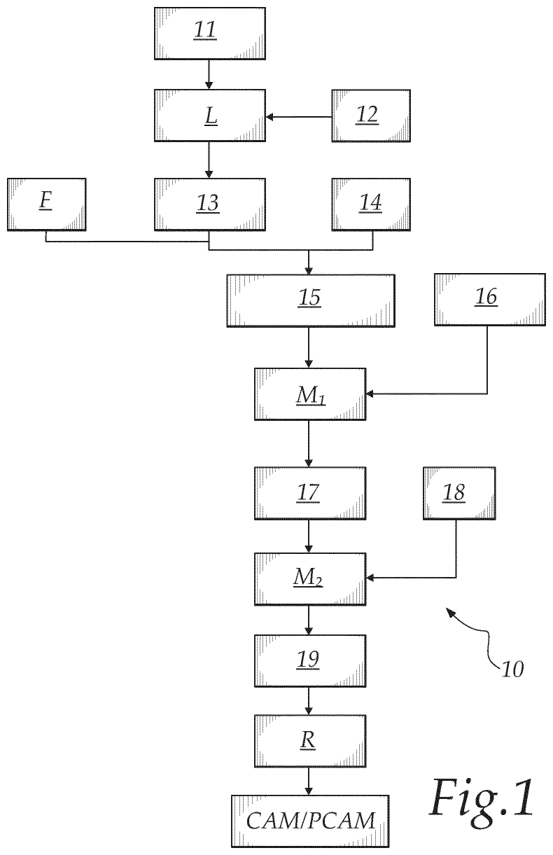

FIG. 1 is a block diagram of the method for obtaining cathode active materials from black mass according to the invention;

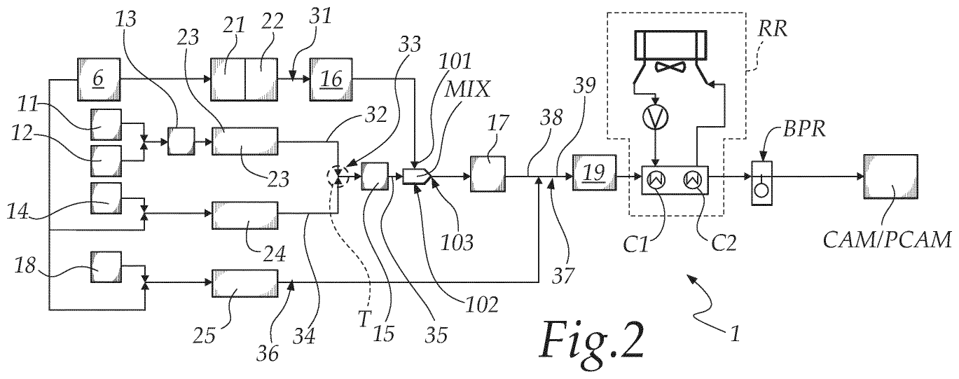

FIG. 2 is a diagram of an apparatus for obtaining cathode active materials according to the invention.

With reference to the figures, a method for obtaining cathode active materials from black mass, according to the invention, is schematically indicated by the reference number 10.

The method 10 consists in:
subjecting the black mass 11 to a leaching operation (indicated with L), by using a leaching agent 12, thus obtaining a leaching liquor 13,
subjecting the leaching liquor 13 to a step of mixing M₁ with supercritical water 16, generating nanoparticle precipitation, thus obtaining a nanoparticle solution 17 of metal oxides,
subjecting the nanoparticle solution 17 to a step of mixing M₂ with a stream 18 of additives and/or cold water to obtain a stoichiometrically correct and/or chemically stable nanoparticle solution 19,
cooling (step R in FIG. 1) such stoichiometrically correct and/or chemically stable nanoparticle solution 19, thus obtaining cathode active materials CAM and/or precursors of cathode active materials PCAM.

The term “leaching liquor”, in the present description, means the solution resulting from the leaching operation.

In particular the leaching agent 12 is one selectively chosen from among organic leaching agents, such as: organic and/or inorganic acids and/or deep eutectic solvents and/or combinations and/or sequences of said acids.

It should be noted that the use of organic leaching agents makes it possible to selectively dissolve the metals of interest with respect to the impurities, which remain in the carbon-containing fraction.

Furthermore, organic leaching agents are destroyed by the high temperatures of the supercritical process and do not generate subproducts or waste to be disposed of and/or they can themselves be recovery materials, for example discards from the food industry.

Preferably, the leaching agent 12 is chosen from among citric acid, sulfuric acid and tartaric acid, lactic acid, oxalic acid, formic acid, acetic acid, or in any case similar acids and/or combinations thereof.

In another embodiment, shown in the figures, between the leaching operation L and the step of mixing M₁ with supercritical water 16 there is a step of adding to the leaching liquor 13 one or more precursors 14 of pure metal to correct the stoichiometry of the leaching liquor 13, thus obtaining a stoichiometrically correct leaching liquor 15.

After the leaching step L, and prior to the step of adding one or more precursors 14 of pure metal to the leaching liquor 13, there is a filtration step F for removing the solid residue containing undissolved or unprecipitated carbon-containing materials and metal contaminants such as copper, iron, aluminum and zinc.

The precursors 14 of pure metal are chosen on the basis of the result that it is desired to obtain in terms of the chemical composition of the cathode active materials CAM.

The step of adding one or more precursors 14 of pure metal to the leaching liquor 13 takes place in a T junction, indicated with T.

In other embodiments, not shown in the figures, the addition of one or more precursors 14 of pure metal to the leaching liquor 13 can also be done differently.

For example it is possible to dose the missing salt of Ni as a solid in a mixing tank, or it is possible to dose a solution of nickel in-line, etc.

Such precursors 14 of pure metal make it possible to correct the stoichiometry of the metals present in the leaching liquor 13 by adding the chemical compounds necessary both to deal with the huge variability in chemical composition of the black mass, and of the various different chemical compositions in demand by the market, based on the intended application and the price of raw materials.

For example, in the automotive sector in the last decade a continuous shift has been seen toward chemical compositions with less cobalt, owing to the considerable price increase.

In particular there has been a gradual shift from NMC111 compositions toward NMC532, NMC6221 and NMC811 compositions, in which the digits indicate the molar ratios between nickel, manganese and cobalt.

The term “supercritical water” in the present description means that the water is at a pressure greater than the critical pressure.

The “critical pressure” is the pressure at which a substance can exist in both gaseous and liquid forms.

The step of mixing M₁ the stoichiometrically correct leaching liquor 15 with supercritical water 16 occurs in a mixer MIX of the type illustrated in Italian patent no. 102019000000979 in the name of the company Particular Materials.

In particular, the mixer MIX, indicated in FIG. 2, comprises, considering the advancement direction of the mixed stream:
a first inlet 101, for a stream of supercritical water 16,
a second inlet 102, for a stream of stoichiometrically correct leaching liquor 15,
a mixing region (not indicated in the figures) between the stream of supercritical water 16 and the flow of stoichiometrically correct leaching liquor 15, arranged downstream of the first inlet 101 and of the second inlet 102,
an outlet 103 for a nanoparticle solution 17 of metal oxides, obtained from the mixing M₁, downstream of the mixing region,
a connecting element (not indicated in the figures) between the first inlet 101 and the second inlet 102 upstream of the mixing region; this connecting element comprises a chamber at the second inlet 102 which surrounds the first inlet 101, and the chamber is in fluidic communication with the mixing region and becomes narrower in the direction of the mixing region.

Advantageously, the step of mixing M₂ the nanoparticle solution 17 with the stream 18 of additives and/or cold water can also serve to block the accretion of nanoparticles.

The invention also relates to an apparatus 1, shown schematically in FIG. 2, for obtaining cathode active materials, according to the invention.

The apparatus 1 comprises:
first pumping means 21, for a stream of water 6,
heating means 22 of the stream of water 6, downstream of the first pumping means 21,
second pumping means 23, for the leaching liquor 13,
third pumping means 24, for a stream of precursors of pure metal 14,
fourth pumping means 25, for the stream 18 of additives and/or cold water,
the mixer MIX,
cooling means RR,
a back pressure regulator BPR.

The first pumping means 21, the second pumping means 23, the third pumping means 24 and the fourth pumping means 25 comprise one or more pumps.

In particular, the first pumping means 21 and the heating means 22 are arranged on a first hydraulic branch 31 of the apparatus 1 and are adapted to bring the stream of water 6 to the conditions of supercritical water 16.

The heating means 22 comprise two heaters in series, not shown in the figures, for example of the type with electric heating elements.

Such heaters are respectively:
a first heater, adapted to bring the temperature of the water 6 from approximately 20° C. to approximately 450° C.,
a second heater, adapted to bring the temperature of the water 6 from approximately 450° C. to approximately 650° C.

The second pumping means 23 are arranged on a first segment 32 of a second hydraulic branch 33 of the apparatus 1.

The third pumping means 24 are arranged on a second segment 34 of the second hydraulic branch 33 of the apparatus 1; the second segment 34 is parallel to the first segment 32.

The first segment 32 and the second segment 34 merge in a third segment 35 of the second hydraulic branch 33.

The third segment 35 of the second hydraulic branch 33 leads into the mixer MIX via the second inlet 102.

The first hydraulic branch 31 leads into the mixer MIX via the first inlet 101.

The fourth pumping means 25 are arranged on a third hydraulic branch 36 of the apparatus 1.

The outlet 103 of the mixer MIX is in fluidic communication with a fourth hydraulic branch 37 of the apparatus 1.

In particular, the fourth hydraulic branch 37 has:
a fourth segment 38, in output from the mixer MIX, and constituted for example by a pipe of INCONEL 625 of length in the order of 1 m,
a fifth segment 39, on which the cooling means RR and the back pressure regulator BPR are arranged.

The third hydraulic branch 36 is connected to the fourth hydraulic branch 37 in the interface region between the fourth segment 38 and the fifth segment 39 of the fourth hydraulic branch 37.

The cooling means RR comprise two heat exchangers C1, C2, for example of the pipe-in-pipe and/or shell-and-tube and/or plate type.

The back pressure regulator BPR is arranged downstream of the cooling means RR considering the advancement direction of the stream.

The back pressure regulator BPR is actuated in order to enable the stream to reach the operating pressure of approximately 230 bar and to depressurize the stream cooled downstream of the cooling means RR.

The operation of the apparatus 1, according to the invention, is as follows.

A stream of leaching liquor 13 is pre-mixed in the T junction with a stream of precursors 14 of pure metal.

For the stream of precursors 14 of pure metal, a KOH solution for example is used, of which the molarity is given by the formula:

$$[ KOH ] = 2 x [ {Co}^{2 +} ] + 2 x [ {Ni}^{2 +} ] + 2 x [ {Mn}^{2 +} ] .$$

The resultant stream of stoichiometrically correct leaching liquor 15 is then sent to the mixer MIX, where it meets a stream of supercritical water 16.

The turbulent mixing of the two streams leads to rapid nanoparticle precipitation 17 with the desired composition.

The resultant dispersion of nanoparticles 17, which is at a high temperature, for example over 300° C., is cooled by means of the cooling means RR, depressurized with the back pressure regulator BPR, and collected in a container with a conical bottom.

The solid product in the form of fine particulate is separated by filtration or centrifugation, washed and dried before being sent to a process of calcination designed to obtain an optimal particle size distribution for use as cathode active material CAM.

It should be noted that experimental tests have shown that with a method and an apparatus according to the invention, the following are obtained:
excellent levels of crystallinity and nanometric size, with absence of spurious phases,
appropriate electrochemical performance levels in charge/discharge cycles, for application of the synthesized materials as cathode active elements of lithium batteries,
the absence of meaningful subproducts in the residual waters after the separation of the particles.

It should also be noted that, if such waters were to contain meaningful residues of metals of high added value, these could be reused in the leaching process.

In addition, it should be noted that, independently of the stoichiometric correction, the method according to the invention returns a mixed oxide of ultra-fine metals, which is a precursor of cathode active materials PCAM of exceptionally high quality for the cathode active materials CAM production industry, without generating waste sulfates.

In this case lithium is recovered in a way that is per se known.

With stoichiometric correction, it is also possible to obtain:
cathode active materials CAM directly,
and/or precursors of cathode active materials PCAM which can be converted to cathode active materials CAM with a heat treatment of a type that is per se known, according to the stoichiometry and particle size distribution/morphology required by the specific application and/or by the market.

In practice it has been found that the invention fully achieves the intended aim and objects by providing a method for obtaining metals from black mass and an apparatus for obtaining cathode active materials, which can be used in such a method, which are simpler and more economic than similar, conventional methods and apparatuses.

Furthermore with the invention a method has been devised for obtaining metals from black mass and an apparatus for obtaining cathode active materials, which can be used in such a method, which enable a reduced and/or absent production of waste to be disposed of, so resulting in a reduced environmental impact with respect to similar, conventional methods and apparatuses.

The invention thus conceived is susceptible of numerous modifications and variations, all of which are within the scope of the appended claims. Moreover, all the details may be substituted by other, technically equivalent elements.

In practice the materials employed, provided they are compatible with the specific use, and the contingent dimensions and shapes, may be any according to requirements and to the state of the art.

The disclosures in Italian Patent Application No. 102023000007830 from which this application claims priority are incorporated herein by reference.

1-18. (canceled)

19. A method for obtaining cathode active materials from black mass, which consists in:
subjecting said black mass to a leaching operation, by using a leaching agent, thus obtaining a leaching liquor,
subjecting said leaching liquor to a step of mixing with supercritical water, generating nanoparticle precipitation, thus obtaining a nanoparticle solution of metal oxides,
subjecting said nanoparticle solution to a step of mixing with a stream of additives and/or cold water to obtain a stoichiometrically correct and/or chemically stable nanoparticle solution,
cooling said stoichiometrically correct and/or chemically stable nanoparticle solution, thus obtaining cathode active materials and/or precursors of cathode active materials.

20. The method according to claim 19, wherein said leaching agent is one from among organic leaching agents, selectively chosen from: organic and/or inorganic acids and/or deep eutectic solvents and/or combinations and/or sequences of said acids.

21. The method according to claim 19, wherein said leaching agent is chosen from among citric acid, sulfuric acid and tartaric acid, lactic acid, oxalic acid, formic acid, acetic acid and/or combinations thereof.

22. The method according to claim 19, wherein between said leaching operation and said step of mixing with supercritical water there is a step of adding to said leaching liquor one or more precursors of pure metal to correct the stoichiometry of said leaching liquor, thus obtaining a stoichiometrically correct leaching liquor.

23. The method according to claim 22, wherein after the leaching operation, and prior to the step of adding said one or more precursors of pure metal to said leaching liquor, there is a filtration step for removing the solid residue containing undissolved or unprecipitated carbon-containing materials and metal contaminants.

24. The method according to claim 22, wherein said step of adding said one or more precursors of pure metal to said leaching liquor takes place in a T junction.

25. The method according to claim 22, wherein said step of mixing said stoichiometrically correct leaching liquor with said supercritical water occurs in a mixer, said mixer comprising, considering an advancement direction of the mixed stream:
a first inlet, for a stream of said supercritical water,
a second inlet, for a stream of said stoichiometrically correct leaching liquor,
a mixing region between said stream of said supercritical water and said stream of said stoichiometrically correct leaching liquor, said mixing region being arranged downstream of said first inlet and of said second inlet,
an outlet for said nanoparticle solution of metal oxides downstream of said mixing region,
a connecting element between said first inlet and said second inlet upstream of said mixing region, said connecting element comprising a chamber at said second inlet which surrounds said first inlet, said chamber being in fluidic communication with said mixing region and becoming narrower in the direction of said mixing region.

26. An apparatus for obtaining cathode active materials, comprising:
first pumping means,
heating means downstream of said first pumping means,
second pumping means,
third pumping means,
fourth pumping means,
a mixer,
cooling means,
a back pressure regulator.

27. The apparatus according to claim 26, wherein said first pumping means, said second pumping means, said third pumping means and said fourth pumping means comprise one or more pumps.

28. The apparatus according to claim 26, wherein said first pumping means and said heating means are arranged on a first hydraulic branch of said apparatus.

29. The apparatus according to claim 26, wherein said heating means comprise two electric resistance heaters in series.

30. The apparatus according to claim 26, wherein:
said second pumping means are arranged on a first segment of a second hydraulic branch of said apparatus,
said third pumping means are arranged on a second segment of said second hydraulic branch of said apparatus, said second segment being parallel to said first segment,
said first segment and said second segment merge in a third segment of said second hydraulic branch.

31. The apparatus according to claim 26, wherein said mixer comprises, considering an advancement direction of a mixed stream:
a first inlet, for a stream of supercritical water,
a second inlet, for a stream of stoichiometrically correct leaching liquor,
a mixing region between said stream of said supercritical water and said stream of said stoichiometrically correct leaching liquor, said mixing region being arranged downstream of said first inlet and of said second inlet,
an outlet for a nanoparticle solution of metal oxides downstream of said mixing region,
a connecting element between said first inlet and said second inlet upstream of said mixing region, said connecting element comprising a chamber at said second inlet which surrounds said first inlet, said chamber being in fluidic communication with said mixing region and becoming narrower in the direction of said mixing region.

32. The apparatus according to claim 30, wherein:
said third segment of said second hydraulic branch leads into said mixer via said second inlet,
said first hydraulic branch leads into said mixer via said first inlet.

33. The apparatus according to claim 26, wherein said fourth pumping means are arranged on a third hydraulic branch of said apparatus.

34. The apparatus according to claim 33, wherein said outlet of said mixer is in fluidic communication with a fourth hydraulic branch of said apparatus, said fourth hydraulic branch having:
a fourth segment, in output from said mixer,
a fifth segment, on which said cooling means and said back pressure regulator are arranged,
said third hydraulic branch being connected to said fourth hydraulic branch in the interface region between said fourth segment and said fifth segment of said fourth hydraulic branch.

35. The apparatus according to claim 26, wherein said cooling means comprise two heat exchangers of the pipe-in-pipe and/or shell-and-tube and/or plate type.

36. The apparatus according to claim 26, wherein said back pressure regulator is arranged downstream of said cooling means considering the advancement direction of the stream.
